(19) United States
(12) Patent Application Publication
(10) Pub. No.: US 2015/0316713 A1
(43) Pub. Date: Nov. 5, 2015

(54) OPTICAL FIBER AND OPTICAL TRANSMISSION SYSTEM

(71) Applicant: SUMITOMO ELECTRIC INDUSTRIES, LTD., Osaka (JP)

(72) Inventors: Yoshinori YAMAMOTO, Yokohama-shi (JP); Masaaki HIRANO, Yokohama-shi (JP)

(21) Appl. No.: 14/337,420

(22) Filed: Jul. 22, 2014

(30) Foreign Application Priority Data
Jul. 29, 2013 (JP) 2013-156476

(51) Int. Cl. G02B 6/02; G02B 6/036

(52) U.S. Cl. CPC G02B 6/0228; G02B 6/03633; G02B 6/02042

(57) ABSTRACT

An optical fiber includes a core and a cladding that surrounds the core. The optical fiber has a group index of 1.465 or less at a wavelength of 1550 nm and an absolute value of chromatic dispersion of 4 ps/nm/km or less at a wavelength of 1550 nm. A relative refractive index difference between the core and pure silica ranges from −0.1% to 0.1%. The core includes a first core disposed at the center of the optical fiber and a second core surrounding the first core. A relative refractive index difference between the first core and the cladding ranges from 0.6% to 0.9%. A relative refractive index difference between the second core and the cladding ranges from 0.02% to 0.12%. The ratio of the diameter of the second core to the diameter of the first core ranges from 2.0 to 6.0.

### BACKGROUND OF THE INVENTION

1. Field of the Invention

The present invention relates to an optical fiber and an optical transmission system.

2. Description of the Related Art

Optical transmission systems including a single-mode optical fiber as a signal light transmission path are demanded to have less time (delay time, or “latency”) for signal light to transmit from a transmitter to a receiver. This demand has been increasing in recent years. For example, a very small difference in delay time on the order of milliseconds or less in financial transactions using an optical transmission system may influence an enormous financial benefit.

The latency T_{L} [s] of signal light in an optical fiber transmission path having a transmission length L [m] is expressed by Equation (1):

$${T}_{L} = \frac{L}{{v}_{g}} = \frac{L}{( c / {n}_{g} )} = \frac{{Ln}_{g}}{c} \qquad ( 1 )$$

where c denotes the speed (3×10⁸ [m/s]) of light in vacuum space, v_{g} denotes the group velocity of signal light in the optical fiber transmission path, and n_{g} denotes the group index of the optical fiber. Equation (1) implies that an optical fiber having a low group index n_{g} is suitable to reduce the latency T_{L}.

An ITU-T Recommendation G.652 compliant standard single-mode fiber (SSMF) has a group index n_{g} of 1.4679. On the other hand, an optical fiber having a low group index n_{g} of 1.4620 is described in John A. Jay, “Low Signal Latency in Optical Fiber Networks”, Proceedings of the 60th IWCS Conference, pp. 429-437 (Non Patent Literature 1).

### SUMMARY OF THE INVENTION

Accordingly, it is an object of the present invention to provide an optical fiber capable of reducing latency of signal light (hereinafter, referred to as “signal latency”) and an optical transmission system including the optical fiber.

A first aspect of the present invention provides an optical fiber including a core and a cladding that surrounds the core. The optical fiber has a group index of 1.465 or less at a wavelength of 1550 nm and an absolute value of chromatic dispersion of 4 ps/nm/km or less at a wavelength of 1550 nm. A second aspect of the present invention provides an optical transmission system including the optical fiber according to the first aspect of the present invention as a signal light transmission path.

According to the present invention, signal latency can be reduced.

### BRIEF DESCRIPTION OF THE DRAWINGS

FIG. 1 is a schematic diagram illustrating an optical transmission system according to an embodiment of the present invention.

FIG. 2 is a schematic diagram illustrating an exemplary refractive index profile of an optical fiber according to an embodiment of the present invention.

FIG. 3 is a graph illustrating the relationship between a group index n_{g} of the optical fiber according to the embodiment at a wavelength of 1550 nm and a relative refractive index difference Δ₁ between a first core and a cladding of the optical fiber.

FIG. 4 is a graph illustrating the relationship between bend loss of the optical fiber according to the embodiment in a diameter of 20 mm and at a wavelength of 1550 nm and the relative refractive index difference Δ₁ between the first core and the cladding.

FIG. 5 is a graph illustrating the relationship between the group index n_{g} of the optical fiber according to the embodiment at a wavelength of 1550 nm and a relative refractive index difference Δ₂ between a second core and the cladding of the optical fiber.

FIG. 6 is a graph illustrating the relationship between a cutoff wavelength of the optical fiber according to the embodiment and the relative refractive index difference Δ₂ between the second core and the cladding.

FIG. 7 is a graph illustrating the relationship between the cutoff wavelength of the optical fiber according to the embodiment and the ratio of the diameter 2b of the second core to the diameter 2a of the first core in the optical fiber.

FIG. 8 is a graph illustrating the relationship between bend loss of the optical fiber according to the embodiment in a diameter of 20 mm and at a wavelength of 1550 nm and the ratio of the diameter 2b of the second core to the diameter 2a of the first core in the optical fiber.

### DESCRIPTION OF THE PREFERRED EMBODIMENTS

The optical fiber described in Non Patent Literature 1 is an ITU-T Recommendation G.652 compliant single-mode fiber and has a chromatic dispersion of approximately 17 ps/nm/km at a wavelength of 1550 nm. Dispersion of transmission optical fiber causes linear noise that is a contributor to degradation in the quality of signal light and, accordingly, has to be compensated by a dispersion compensation module. The inventor has found that signal latency cannot be reduced merely by reducing a group index n_{g} of an optical fiber used as a transmission path in an optical transmission system.

Examples of the dispersion compensation module include a dispersion compensating optical fiber (DCF) that has dispersion of a different sign from dispersion of a transmission optical fiber and has a large absolute value of the dispersion. Although the transmission optical fiber has a length ranging from, for example, 80 km to 100 km per span, the DCF has a length ranging from a few kilometers to several tens of kilometers per span. Since the transmission optical fiber and the DCF are connected in series, signal latency increases depending on the length of the DCF.

A digital signal processor (DSP) typically represented by digital coherent technology may be used as a dispersion compensation module. The DSP, serving as a dispersion compensation module, is included in a receiver and is configured to equalize waveform distortion of signal light caused by dispersion in a transmission optical fiber. To equalize the waveform distortion of signal light caused by a large dispersion, the number of taps in the DSP has to be increased. Signal latency increases depending on the number of taps in the DSP.

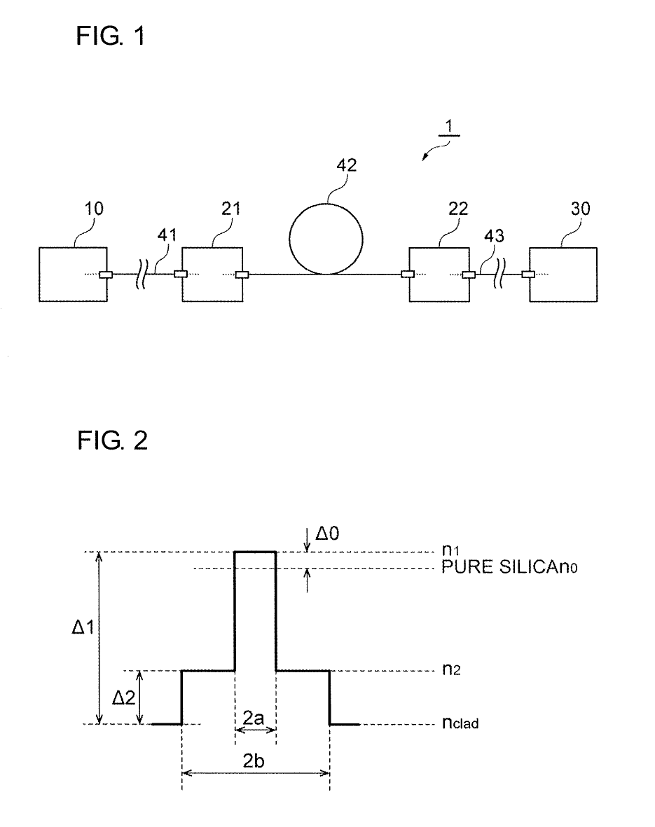

Embodiments of the present invention will be described in detail with reference to the accompanying drawings. FIG. 1 is a schematic diagram illustrating an optical transmission system 1 according to an embodiment of the present invention. The optical transmission system 1 includes a transmitter 10, repeaters 21 and 22, a receiver 30, and optical fibers 41, 42, and 43, serving as transmission paths for signal light. The transmitter 10, the repeaters 21 and 22, and the receiver 30 each include an optical amplifier to amplify the signal light. The signal light transmitted from the transmitter 10 passes through the optical fiber 41, the repeater 21, the optical fiber 42, the repeater 22, and the optical fiber 43 in that order, and reaches the receiver 30. The signal light is received by the receiver 30.

An optical fiber according to an embodiment of the present invention is suitably used as the optical fibers 41 to 43. The optical fiber according to the embodiment has a group index n_{g} of 1.465 or less at a wavelength of 1550 nm and an absolute value of chromatic dispersion of 4 ps/nm/km or less at a wavelength of 1550 nm. The group index n_{g} of the optical fiber is expressed by Equations (2) and (3):

$$\begin{matrix}{n}_{g} = {n}_{eff} + ω \frac{d {n}_{eff}}{d ω} & ( 2 ) \\ {n}_{eff} = \frac{β}{k} = \frac{βλ}{2 π} & ( 3 )\end{matrix}$$

where n_{eff} denotes the effective refractive index of a propagation mode qualitatively obtained by weighting the refractive index of a core of the optical fiber and the refractive index of a cladding thereof with optical power distribution of propagated light, ω denotes the angular frequency of light, β denotes the propagation constant of the propagation mode, k denotes the wave number of light, and λ denotes the wavelength of light.

If the group index n_{g} is less than or equal to 1.465, a latency of 10 μs can be reduced per 1,000-km length as compared with the SSMF. Furthermore, the group index n_{g} of the optical fiber is preferably less than or equal to 1.462. If the group index n_{g} is 1.462 or less, a latency of 20 μs can be reduced per 1,000-km length as compared with the SSMF.

The optical fiber according to the embodiment of the present invention preferably includes two or more layered cores and a cladding. FIG. 2 is a schematic diagram illustrating an exemplary refractive index profile of the optical fiber according to this embodiment. The optical fiber of FIG. 2 includes a first core disposed at the center of the optical fiber, a second core that surrounds the first core, and a cladding that surrounds the second core. Let n₁ and 2a denote the refractive index and diameter of the first core, respectively, let n₂ and 2b denote the refractive index and diameter of the second core, respectively, let n_{clad} denote the refractive index of the cladding, and let n₀ denote the refractive index of pure silica.

A relative refractive index difference Δ₁ [%] between the first core and the cladding is expressed by Equation (4).

$${Δ}_{1} = 100 \times \frac{{n}_{1} - {n}_{clad}}{{n}_{1}} \qquad ( 4 )$$

A relative refractive index difference Δ₂ [%] between the second core and the cladding is expressed by Equation (5).

$${Δ}_{2} = 100 \times \frac{{n}_{2} - {n}_{clad}}{{n}_{2}} \qquad ( 5 )$$

A relative refractive index difference Δ₀ [%] between the first core and pure silica is expressed by Equation (6).

$${Δ}_{0} = 100 \times \frac{{n}_{1} - {n}_{0}}{{n}_{1}} \qquad ( 6 )$$

The magnitude relationship between the refractive indices of regions in the optical fiber illustrated in FIG. 2 is n₁>n₀>n₂>n_{clad} or n₀>n₁>n₂>n_{clad}. This optical fiber is predominantly composed of silica glass and is doped with impurities to control the refractive index in the regions as necessary. The first core may be made of pure silica without being doped with a refractive index increaser, such as Ge. Each of the second core and the cladding may be doped with a refractive index depressant, such as F.

Preferably, the relative refractive index difference Δ₀ between the first core and pure silica ranges from −0.1% to 0.1%. Reducing the refractive index of the first core through which most of signal light passes can reduce the group index n_{g}. Furthermore, the core is preferably not doped with Ge. To negatively increase the relative refractive index difference Δ₀, the first core would have to be doped with a large amount of F, thus leading to an increase in attenuation. It is not preferable from the viewpoint of manufacturability.

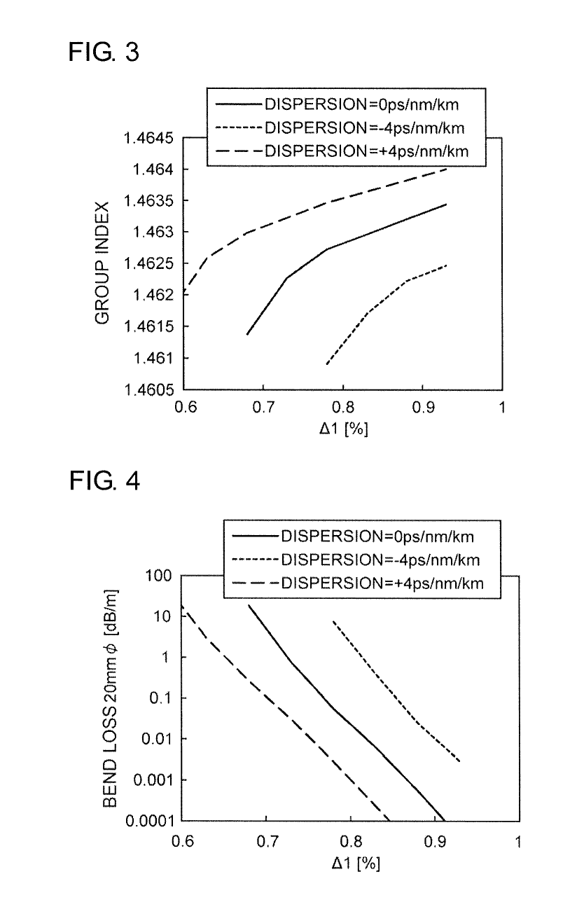

FIG. 3 is a graph illustrating the relationship between the group index n_{g} of the optical fiber of FIG. 2 at a wavelength of 1550 nm and the relative refractive index difference Δ₁ between the first core and the cladding of the optical fiber. FIG. 4 is a graph illustrating the relationship between bend loss of the optical fiber of FIG. 2 in a diameter of 20 mm and at a wavelength of 1550 nm and the relative refractive index difference Δ₁ between the first core and the cladding. In this case, the relative refractive index difference Δ₀ between the first core and pure silica is 0.06%, the relative refractive index difference Δ₂ between the second core and the cladding is 0.08%, the ratio (2b/2a) of the diameter 2b of the second core to the diameter 2a of the first core is 4.0, and chromatic dispersions at a wavelength of 1550 nm are −4 ps/nm/km, 0 ps/nm/km, and +4 ps/nm/km.

FIG. 3 demonstrates that the relative refractive index difference Δ₁ has to be less than or equal to 0.9% so that the group index n_{g} of the optical fiber is less than or equal to 1.464. In addition, FIG. 4 demonstrates that the relative refractive index difference Δ₁ has to be greater than or equal to 0.6% so that the bend loss of the optical fiber is less than or equal to 20 dB/m at which there is no problem in practical use. Thus, the relative refractive index difference Δ₁ preferably ranges from 0.6% to 0.9%.

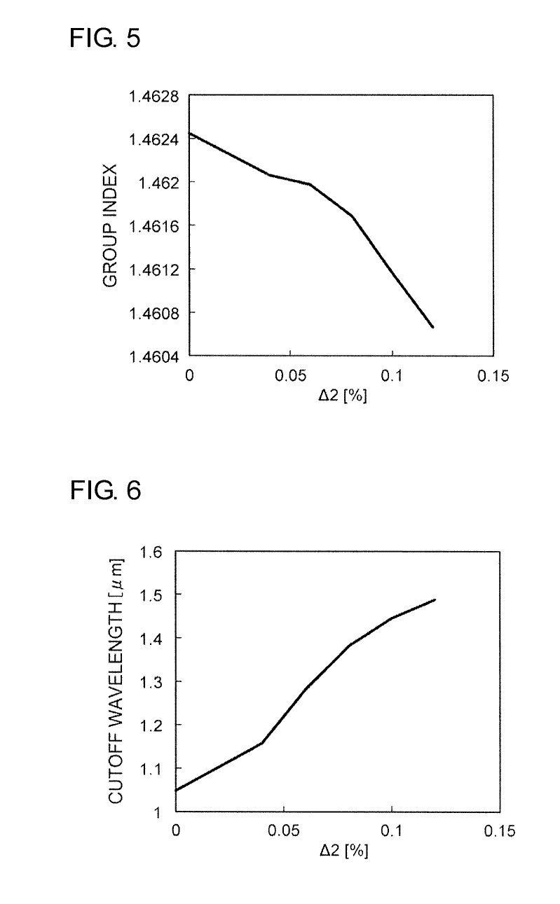

FIG. 5 is a graph illustrating the relationship between the group index n_{g} of the optical fiber of FIG. 2 at a wavelength of 1550 nm and the relative refractive index difference Δ₂ between the second core and the cladding of the optical fiber. FIG. 6 is a graph illustrating the relationship between a cutoff wavelength of the optical fiber of FIG. 2 and the relative refractive index difference Δ₂ between the second core and the cladding. In this case, the relative refractive index difference Δ₀ between the first core and pure silica is 0.06%, the relative refractive index difference Δ₁ between the first core and the cladding is 0.73%, the ratio (2b/2a) of the diameter 2b of the second core to the diameter 2a of the first core is 4.0, and chromatic dispersion at a wavelength of 1550 nm is 0 ps/nm/km.

FIG. 5 demonstrates that as the relative refractive index difference Δ₂ is larger, the group index n_{g} is lower, and the relative refractive index difference Δ₂ accordingly has to be greater than or equal to 0.02% so that the group index n_{g} of the optical fiber is less than or equal to 1.462. Furthermore, FIG. 6 demonstrates that when the relative refractive index difference Δ₂ is too large, the cutoff wavelength is long, and the relative refractive index difference Δ₂ accordingly has to be less than or equal to 0.12% so that the cutoff wavelength is less than or equal to 1.53 μm to achieve a single-mode operation at C-band. Thus, the relative refractive index difference Δ₂ preferably ranges from 0.02% to 0.12%.

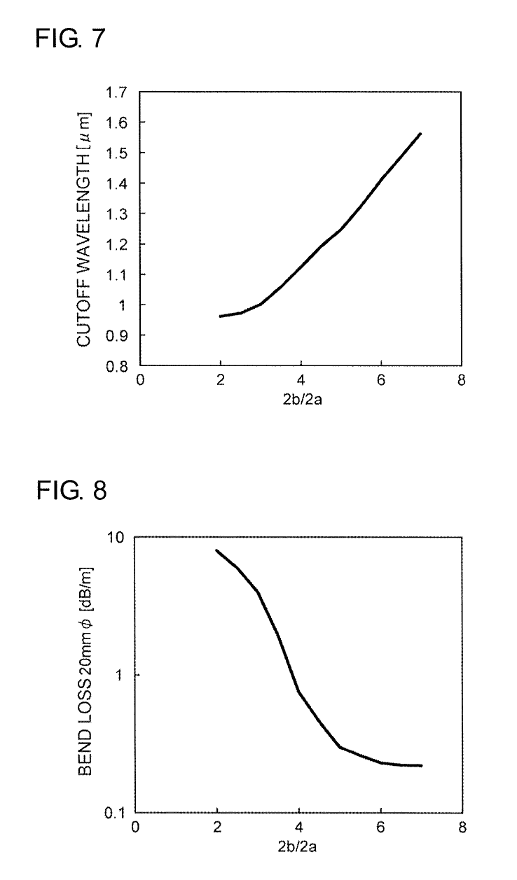

FIG. 7 is a graph illustrating the relationship between the cutoff wavelength of the optical fiber of FIG. 2 and the ratio (2b/2a) of the diameter 2b of the second core to the diameter 2a of the first core in the optical fiber. FIG. 8 is a graph illustrating the relationship between bend loss of the optical fiber of FIG. 2 in a diameter of 20 mm and at a wavelength of 1550 nm and the ratio (2b/2a) of the diameter 2b of the second core to the diameter 2a of the first core. In this case, the relative refractive index difference Δ₀ between the first core and pure silica is 0.06%, the relative refractive index difference Δ₁ between the first core and the cladding is 0.73%, the relative refractive index difference Δ₂ between the second core and the cladding is 0.08%, and chromatic dispersion at a wavelength of 1550 nm is 0 ps/nm/km.

FIG. 7 demonstrates that as the ratio 2b/2a is larger, the cutoff wavelength is longer, and the ratio 2b/2a accordingly has to be less than or equal to 6.0 so that the cutoff wavelength is less than or equal to 1.53 μm to achieve a single-mode operation at C-band. Furthermore, FIG. 8 demonstrates that as the ratio 2b/2a is smaller, the bend loss is larger, and the ratio 2b/2a accordingly has to be greater than or equal to 2.0 so that the bend loss is less than or equal to 10 dB/m. Considering the cutoff wavelength and the bend loss, therefore, the ratio (2b/2a) of the diameter 2b of the second core to the diameter 2a of the first core preferably ranges from 2.0 to 6.0. Note that the ratio 2b/2a does not significantly influence the group index n_{g}.

The above-described results obtained from FIGS. 3 to 8 reveal that, preferably, the core of the optical fiber according to the embodiment of the present invention includes the first core disposed at the center of the optical fiber and the second core surrounding the first core, the relative refractive index difference Δ₁ between the first core and the cladding ranges from 0.6% to 0.9%, the relative refractive index difference Δ₂ between the second core and the cladding ranges from 0.02% to 0.12%, and the ratio (2b/2a) of the diameter 2b of the second core to the diameter 2a of the first core ranges from 2.0 to 6.0.

Table I describes the specifications of optical fibers according to Examples 1 to 11. Table II describes the characteristics of the optical fibers according to Examples 1 to 11. These tables also describe the specifications and characteristics of a related-art single-mode optical fiber (SMF) according to Comparative Example 1 and those of a related-art dispersion shifted optical fiber (DSF) according to Comparative Example 2.

TABLE I

| | Comparative example | | | | | | |
|---|---|---|---|---|---|---|---|
| | 1 | 2 | Example | | | | |
| Index profile | (SMF) | (DSF) | 1 | 2 | 3 | 4 | 5 |
| Δ₀ (%) | 0.34 | 0.72 | 0.00 | 0.06 | 0.09 | −0.08 | −0.03 |
| Δ₁ (%) | 0.34 | 0.72 | 0.73 | 0.73 | 0.88 | 0.71 | 0.62 |
| Δ₂ (%) | — | 0.07 | 0.08 | 0.08 | 0.08 | 0.06 | 0.02 |
| 2b/2a | — | 3.8 | 4.0 | 4.0 | 3.5 | 4.0 | 4.5 |
| 2a (μm) | 8.4 | 4.1 | 4.4 | 4.4 | 4.3 | 4.5 | 5.0 |

| | Example | | | | | |
|---|---|---|---|---|---|---|
| Index profile | 6 | 7 | 8 | 9 | 10 | 11 |
| Δ₀ (%) | 0.06 | 0.00 | 0.02 | 0.00 | 0.06 | 0.06 |
| Δ₁ (%) | 0.72 | 0.76 | 0.79 | 0.78 | 0.89 | 0.63 |
| Δ₂ (%) | 0.12 | 0.06 | 0.04 | 0.08 | 0.04 | 0.08 |
| 2b/2a | 3.5 | 5.0 | 6.0 | 2.0 | 4.0 | 4.0 |
| 2a (μm) | 4.5 | 4.5 | 4.7 | 3.9 | 4.8 | 4.5 |

TABLE II

| | Comparative | | | | | | |
|---|---|---|---|---|---|---|---|
| | example | | | | | | |
| Characteristics | 1 | 2 | Example | | | | |
| at 1550 nm | (SMF) | (DSF) | 1 | 2 | 3 | 4 | 5 |
| Attenuation (dB/km) | 0.19 | 0.20 | 0.17 | 0.16 | 0.18 | 0.18 | 0.17 |
| Group index | 1.4677 | 1.4711 | 1.4608 | 1.4617 | 1.4626 | 1.4600 | 1.4613 |
| Chromatic dispersion | 16.8 | 0.00 | −0.20 | 0.08 | −1.34 | 0.42 | 3.77 |
| (ps/nm/km) | | | | | | | |
| Dispersion slope | 0.058 | 0.065 | 0.059 | 0.059 | 0.049 | 0.055 | 0.049 |
| (ps/nm²/km) | | | | | | | |
| MFD (μm) | 10.3 | — | 7.8 | 7.8 | 6.9 | 7.8 | 8.0 |
| Aeff (μm²) | 80 | 45 | 46 | 45 | 35 | 45 | 47 |
| Cutoff wavelength | — | 1350 | 1390 | 1383 | 1295 | 1275 | 1128 |
| (nm) | | | | | | | |
| Bend loss in a | 6.0 | 0.9 | 0.8 | 0.8 | <0.1 | 1.5 | 7.0 |
| diameter of 20 mm | | | | | | | |
| (dB/m) | | | | | | | |

| Characteristics | Example | | | | | |
|---|---|---|---|---|---|---|
| at 1550 nm | 6 | 7 | 8 | 9 | 10 | 11 |
| Attenuation (dB/km) | 0.17 | 0.16 | 0.17 | 0.17 | 0.16 | 0.17 |
| Group index | 1.4618 | 1.4613 | 1.4622 | 1.4603 | 1.4634 | 1.4615 |
| Chromatic dispersion | 3.09 | −0.51 | 1.61 | −3.03 | 3.76 | 2.53 |
| (ps/nm/km) | | | | | | |
| Dispersion slope | 0.064 | 0.048 | 0.042 | 0.053 | 0.040 | 0.067 |
| (ps/nm²/km) | | | | | | |
| MFD (μm) | 8.1 | 7.4 | 7.1 | 7.4 | 7.0 | 8.7 |
| Aeff (μm²) | 48 | 41 | 37 | 40 | 33 | 56 |
| Cutoff wavelength | 1503 | 1488 | 1514 | 995 | 1316 | 1396 |
| (nm) | | | | | | |
| Bend loss in a | 0.2 | 0.2 | <0.1 | 7.1 | <0.1 | 11.0 |
| diameter of 20 mm | | | | | | |
| (dB/m) | | | | | | |

As described above, since the group index n_{g} of the optical fiber according to the embodiment of the present invention is low, 1.465 or less, signal latency can be reduced. In addition, since the absolute value of optical fiber chromatic dispersion in this embodiment is small, 4 ps/nm/km or less, it is unnecessary to provide a dispersion compensation module, which gives a signal latency, or it needs a dispersion compensation module which gives little signal latency. The optical fiber according to the embodiment of the present invention and the optical transmission system including the optical fiber as a signal light transmission path can reduce signal latency.

What is claimed is:

1. An optical fiber comprising:
a core; and
a cladding that surrounds the core,
wherein the optical fiber has a group index of 1.465 or less at a wavelength of 1550 nm and an absolute value of chromatic dispersion of 4 ps/nm/km or less at a wavelength of 1550 nm.

2. The optical fiber according to claim 1,
wherein a relative refractive index difference between the core and pure silica ranges from −0.1% to 0.1%.

3. The optical fiber according to claim 1,
wherein the core includes a first core disposed at the center of the optical fiber and a second core surrounding the first core,
wherein a relative refractive index difference between the first core and the cladding ranges from 0.6% to 0.9%,
wherein a relative refractive index difference between the second core and the cladding ranges from 0.02% to 0.12%, and
wherein the ratio of the diameter of the second core to the diameter of the first core ranges from 2.0 to 6.0.

4. The optical fiber according to claim 3,
wherein the core is free from Ge.

5. An optical transmission system comprising the optical fiber according to claim 1 as a signal light transmission path.
